(19) United States
(12) Patent Application Publication
(10) Pub. No.: US 2016/0148152 A1
(43) Pub. Date: May 26, 2016

(54) SHOPPING SUPPORTING SYSTEM

(71) Applicant: TOSHIBA TEC KABUSHIKI KAISHA, Tokyo (JP)

(72) Inventor: Jun Iwamoto, Shizuoka-ken (JP)

(21) Appl. No.: 15/014,094

(22) Filed: Feb. 3, 2016

Related U.S. Application Data
(62) Division of application No. 14/260,648, filed on Apr. 24, 2014.

(51) Int. Cl. G06Q 10/08; G06Q 20/20

(52) U.S. Cl. CPC G06Q 10/0833; G06Q 20/202; G06Q 20/209; G06Q 20/208; G06Q 10/0835

(57) ABSTRACT

A shopping supporting system for supporting a customer in moving the purchased commodity comprises a shopping supporting management server, a sales settlement terminal, a store server and a reader/writer, wherein the shopping supporting management server comprises a customer information management section; a delivery number issuing section; a delivery number management section; a delivery information management section; and a delivery method determination section; the sales settlement terminal; a purchase amount calculation section; a delivery condition input section; and a delivery slip output section; the store server; and the reader/writer acquires.

### CROSS-REFERENCE TO RELATED APPLICATION

This application is a Division of application Ser. No. 14/260,648 filed on Apr. 24, 2014, the entire contents of which are incorporated herein by reference.

### FIELD

Embodiments described herein relate to a shopping supporting system used in a large-scale commercial facility.

### BACKGROUND

Large-scale commercial facilities called shopping malls have been put into use. Containing a great many of stores for a large number of customers to shop, those shopping malls are large in area and equipped with a large parking lot.

After shopping in a store, a customer sometimes enters another store carrying the purchased commodity. However, carrying a large commodity or a great many of commodities makes the shopping inconvenient. Thus, in most cases, the customer delivers the purchased commodities to his/her car parked in the parking lot and then goes back to shop, which is troublesome and time-consuming as the facility or the parking lot is large. It is also considered to use a rental locker or a temporary commodity storage office to free the customer from shopping with the purchased commodities, however, the customer has to deliver commodities to the parking lot from the rental locker or the temporary commodity storage office.

Thus, it is still considered to give the purchased commodities to a robot serving in a store which delivers the commodities to a storage position for the customer to receive the commodities once before the settlement. However, it is possible that the customer cancels the purchase of some commodities before the settlement, which decreases the sales opportunities of certain stores.

### BRIEF DESCRIPTION OF THE DRAWINGS

FIG. 1 is a diagram exemplifying the configuration of a system according to the present embodiment;

FIG. 2 is a diagram exemplifying the configuration of a POS terminal according to the present embodiment;

FIG. 3 is a diagram exemplifying the configuration of a store server according to the present embodiment;

FIG. 4 is a diagram exemplifying the configuration of the server of the whole system according to the present embodiment;

FIG. 5 is a flowchart illustrating the flow from the sales of a commodity to the delivery acceptance of the commodity according to the present embodiment;

FIG. 6 is an example of the items of the management information in a delivery number management section according to the present embodiment;

FIG. 7 is an example of the items of the delivery information in a delivery information management section according to the present embodiment;

FIG. 8 is an example of the items of the management information in a delivery number management section according to the present embodiment;

FIG. 9 is a flowchart illustrating a flow started after the delivery of a commodity is accepted and ended after the delivery of the commodity is started according to the present embodiment;

FIG. 10 is an example of the items of the delivery information in a delivery information management section according to the present embodiment;

FIG. 11 is a flowchart illustrating a flow starting with the start of the delivery of a commodity and ending with the arrival of the commodity at a delivery destination according to the present embodiment;

FIG. 12 is an example of the items of the delivery information in a delivery information management section according to the present embodiment;

FIG. 13 is a flowchart illustrating the flow of the delivery of a commodity to a customer at a delivery destination according to the present embodiment; and

FIG. 14 is an example of the items of the delivery information in a delivery information management section according to the present embodiment.

### DETAILED DESCRIPTION

A shopping supporting system for supporting the customer in moving the purchased commodity comprises a shopping supporting management server, a sales settlement terminal, a store server and a reader/writer, wherein the shopping supporting management server comprises a customer information management section configured to manage information of a customer using the shopping supporting system; a delivery number issuing section configured to issue the delivery number of a commodity delivered using the shopping supporting system; a delivery number management section configured to manage the delivery number; a delivery information management section configured to manage the delivery information of the commodity delivered using the shopping supporting system; and a delivery method determination section configured to determine a method for the delivery of the purchased commodity in the shopping supporting system; the sales settlement terminal comprises a temporary data storage section configured to store data of the commodity to be purchased temporarily; a purchase amount calculation section configured to calculate the amount of the commodity to be purchased; a delivery condition input section configured to input a commodity delivery condition based on the shopping supporting system; and a delivery slip output section configured to output data of a delivery slip; the store server comprises a commodity information management section configured to manage commodity information of the commodity to be purchased; and the reader/writer configured to acquire the delivery number associated with the commodity from the code information or a tag attached to the commodity to be purchased.

The shopping supporting system according to the present embodiment is described below in detail with reference to the accompanying drawings.

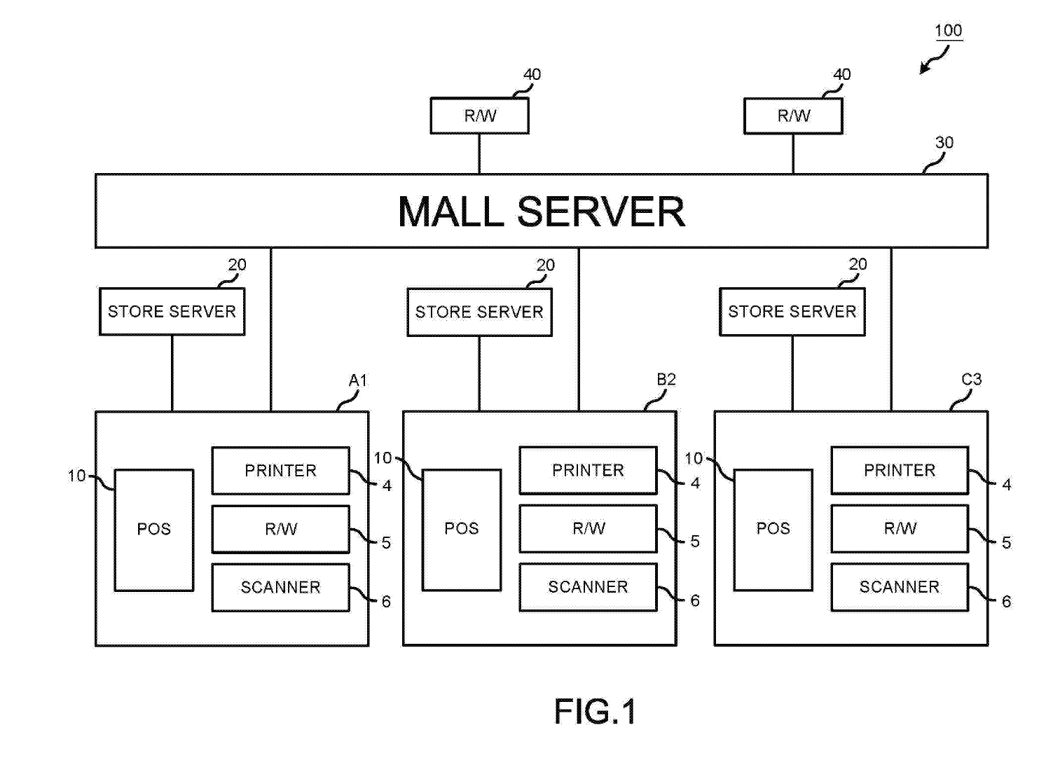

FIG. 1 is a diagram exemplifying the configuration of the system according to the present embodiment.

The shopping supporting system 100 includes a mall server 30 serving as the management server of the shopping supporting system for managing the customer information in a great many of stores in a shopping mall and stores A1, B2 and C3 which are connected with the mall server 30 via a network.

The store A1 is a commodity selling store in the shopping mall which is connected with a printer 4 for outputting a receipt or a commodity receiving slip after the sold commodities are settled, a reader/writer (R/W) 5 for carrying out data communication with a RFID tag attached to a commodity and a scanner 6 for acquiring a customer code or a commodity code along with a POS (point of sale) terminal 10 serving as a sales settlement terminal for carrying out a settlement when selling a commodity. Further, the POS terminal 10 is connected with a store server 20 which is equipped in each store to manage information of commodities for sale.

Further, like in the store A1, a POS terminal 10, a printer 4, a reader/writer 5 and a scanner 6 are also arranged in the stores B2 and C3 in the shopping mall.

Although it is described here that there are three stores in a shopping mall, the number of the stores may be 1, 2, 4 or more.

Further, the mall server 30 is connected with a plurality of reader/writers 40 for exchanging information with the under-mentioned RFID tag attached to a commodity.

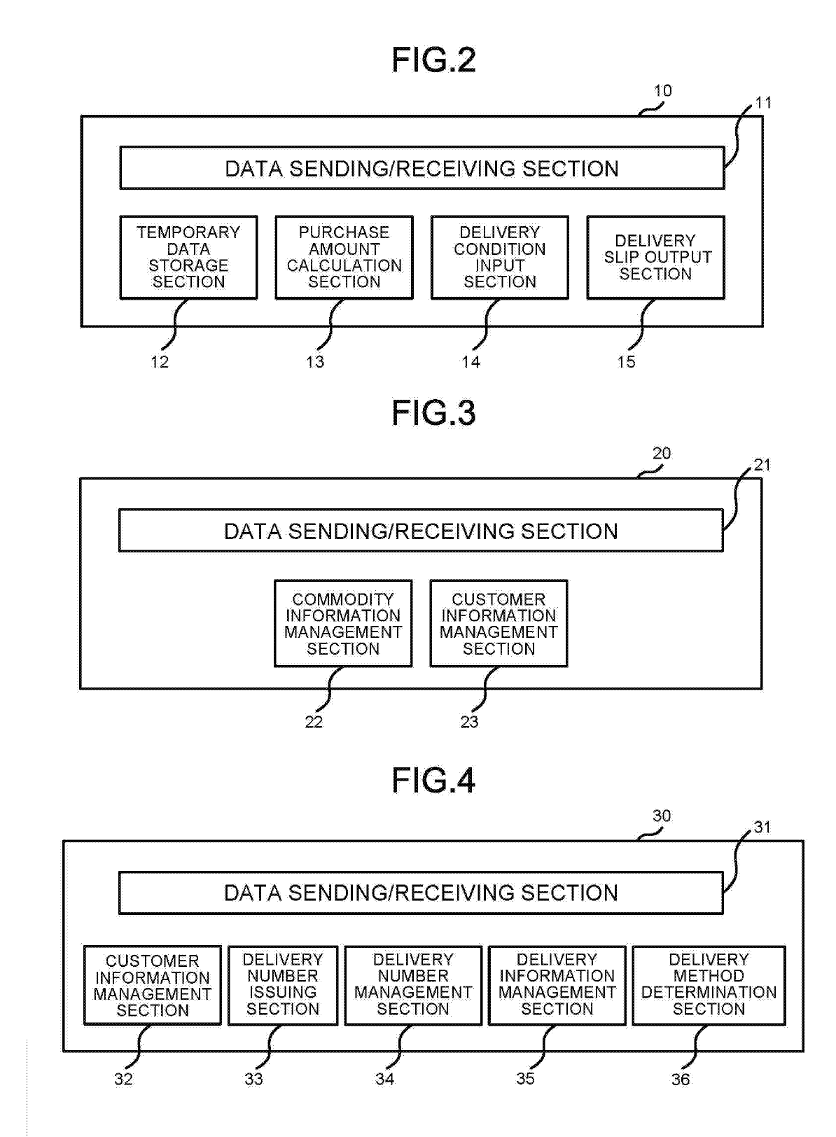

The POS terminal 10 serving as the sales settlement terminal is described in detail in FIG. 2. The POS terminal 10 comprises a data sending/receiving section 11 configured to carry out data sending/reception with other connected servers; a temporary data storage section 12 configured to temporarily store information of the purchased commodity brought to a checkout counter by a customer who purchased the commodity; a purchase amount calculation section 13 configured to calculate the settlement amount of the purchased commodity; a delivery condition input section 14 configured to input a delivery condition; and a delivery slip output section 15 configured to output a delivery slip after the acceptance of a delivery is completed.

Next, the store server 20 is described in detail in FIG. 3. The store server 20 comprises a data sending/receiving section 21 configured to carry out data sending/reception with other connected servers or the POS terminal 10; a commodity information management section 22 configured to manage information of commodities for sale; and a customer information management section 23 for managing customer information.

Next, the mall server 30 serving as the management server of the shopping supporting system is described in detail in FIG. 4. In the mall server 30, there is a data sending/receiving section 31 configured to carry out data sending/reception with other connected servers or the POS terminal 10; a customer information management section 32 configured to manage customer information; a delivery number issuing section 33 configured to issue a delivery number for the use using the shopping supporting system 100; a delivery number management section 34 configured to manage delivery number information of a commodity delivered using the shopping supporting system 100; a delivery information management section 35 configured to manage the delivery information of the commodity delivered using the shopping supporting system 100; and a delivery method determination section 36 configured to determine how the commodity is delivered in the shopping supporting system 100.

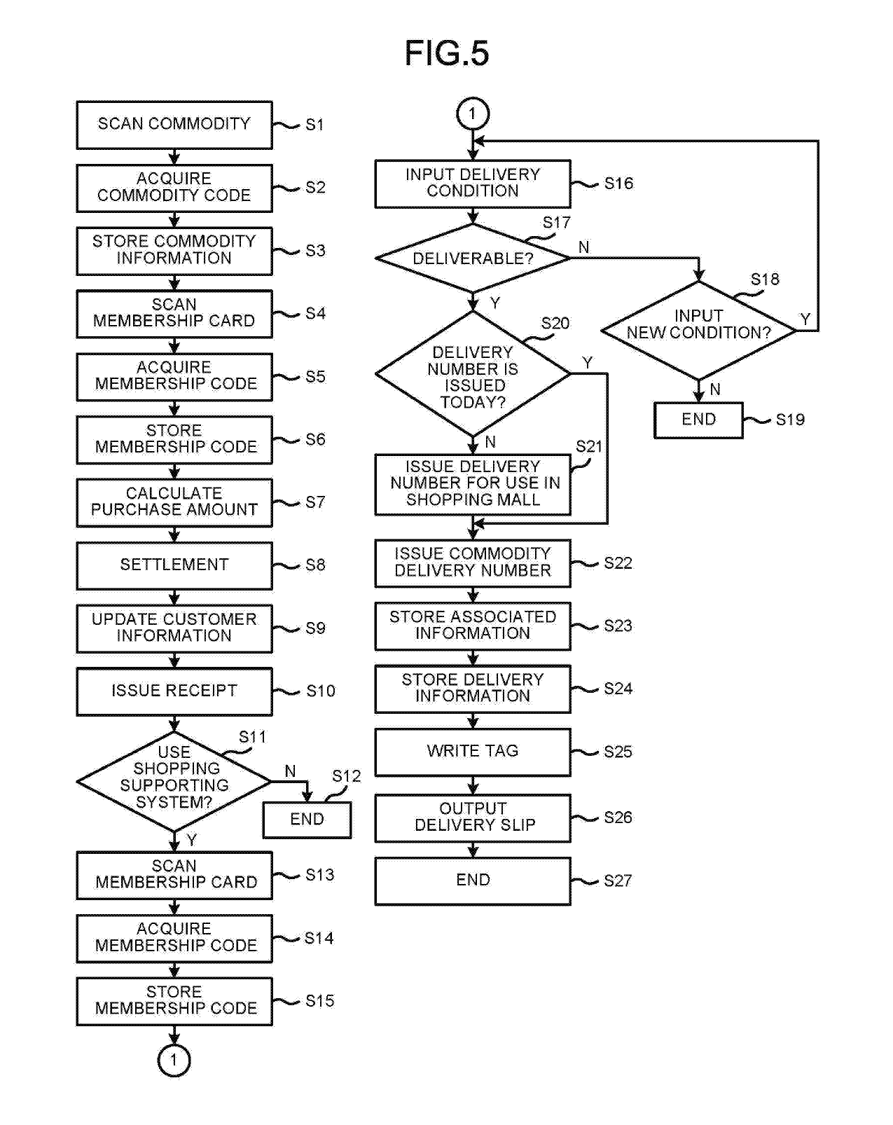

The flow of the acceptance of the delivery of a purchased commodity by the shopping supporting system 100 is described below with reference to the flowchart shown in FIG. 5.

A customer brings desirable commodities to a checkout counter. Further, it is assumed in the embodiment a commodity X is purchased in the store A1.

The operator in the store A1 scans the commodity X with the scanner 6 connected with the POS terminal 10 (S1) to acquire the inherent code of the commodity the customer desires to purchase (S2) and sends the code to the store server 20. The commodity information management section 22 of the store server 20 returns information of the commodity matching with the received inherent code of the commodity the customer desires to purchase to the temporary data storage section 12 of the POS terminal 10 to store the information in the temporary data storage section 12 (S3). Further, the customer hands a membership card and the desirable commodity to the operator. The operator in the store A1 scans the membership card with the scanner 6 connected with the POS terminal 10 (S4) to acquire a unique membership code (S5) and stores the code in the temporary data storage section 12 of the POS terminal 10 (S6).

Sequentially, the purchase amount calculation section 13 of the POS terminal 10 calculates a purchase amount based on the commodity information stored in the temporary data storage section 12 (S7).

After the calculated purchase amount is settled (S8), the customer information is rewritten as the latest information by a customer information update section (not shown) and updated as the latest information in the customer information management section 23 (S9), meanwhile, the printer 4 issues a receipt (S10). Further, the customer information refers here to points given to the customer according to the purchase amount, the latest purchase date and time and the like.

Next, the operator inquires that whether to just bring the purchased commodity away or to deliver the purchased commodity to a designated position using the shopping supporting system 100 (S11). If the purchased commodity is to be just brought away without using the shopping supporting system 100 (N in S11), the commodity is given to the customer, and then the sale is ended (S12).

If the purchased commodity is to be delivered to a designated position using the shopping supporting system 100 (Y in S11), the operator gets the membership card of the customer for use in the shopping supporting system, the operator in the store A1 scans the membership card with the scanner 6 connected with the POS terminal 10 (S13) to acquire the unique membership code (S14) and sends the code to the customer information management section 32 of the mall server 30. Further, different from the customer information managed in the customer information management section 23 of the store server 20, the membership information is information of all the customers using the shopping supporting system 100 in the shopping mall and is registered in advance by the users of the shopping supporting system 100.

The customer information management section 32 extracts a matched one from the unique membership codes sent thereto and stores the extracted membership code in the delivery number issuing section 33 (S15).

Next, the operator inquires the customer about when and where the commodity needs to be delivered and inputs the information into the delivery condition input section 14 (S16). Further, it is described in the embodiment that the delivery can be performed in all the stores in the shopping mall and the delivery destinations capable of being designated are ‘A point’, ‘B point’ and ‘C point’ which are set in advance in the shopping mall.

After a delivery destination, delivery time information and the delivery source store information and the commodity information are input into the delivery condition input section 14, the information is sent to the delivery method determination section 36.

A delivery determination section (not shown) is arranged on the delivery method determination section 36 to determine whether or not a delivery is achievable according to the received delivery destination, delivery time information and delivery resource store information and commodity information (S17), determine a delivery route if the delivery is achievable or send a response ‘undeliverable’ after determining the delivery is unachievable (N in S17). Further, ‘undeliverable’ refers to a situation that the commodity cannot be delivered to a distant delivery destination within a short time or the commodity is fragile and not suitable to be delivered. Further, a condition for the determination on ‘undeliverable’ can be set optionally by the operator of the shopping supporting system 100. If the delivery is unachievable, it is confirmed whether or not to change the condition and input a new condition (S18); a new condition is input (S16) if the customer determines to input a new condition (Y in S18), and if the customer determines not to input a new condition (N in S18), that is, the customer determines to carry the commodity, then the processing is ended (S19).

If the delivery determination section determines the delivery is achievable (Y in S17), the delivery number issuing section 33 confirms whether or not a delivery number is issued for the customer today in the whole shopping mall (S20). The reason lies in that in most cases, commodities purchased in different stores are received together at the same position. If the delivery number for use in the whole shopping mall is issued every time the customer shops at a store, then the customer must receive the under-mentioned delivery slip every time and present all the delivery slips when receiving commodities. Nevertheless, if a single delivery number is issued for a customer to use in the whole shopping mall for one day, then even if a plurality of commodities are purchased, as long as the commodities are stored in association with the single delivery number in the whole shopping mall, consequentially, the customer can receive all the purchased commodities together by presenting the single delivery slip. Further, to prevent the commodities purchased by a customer from being falsely received by a person who picks up the delivery slip, a personal identification number is set when the delivery number is issued in the shopping mall.

Thus, it is confirmed whether or not a delivery number is issued today for the customer to use in the whole shopping mall.

If no delivery number is issued today for the customer to use in the whole shopping mall (N in S20), a delivery number for use in the whole shopping mall is issued (S21), and a commodity delivery number for the single commodity A is issued (S22).

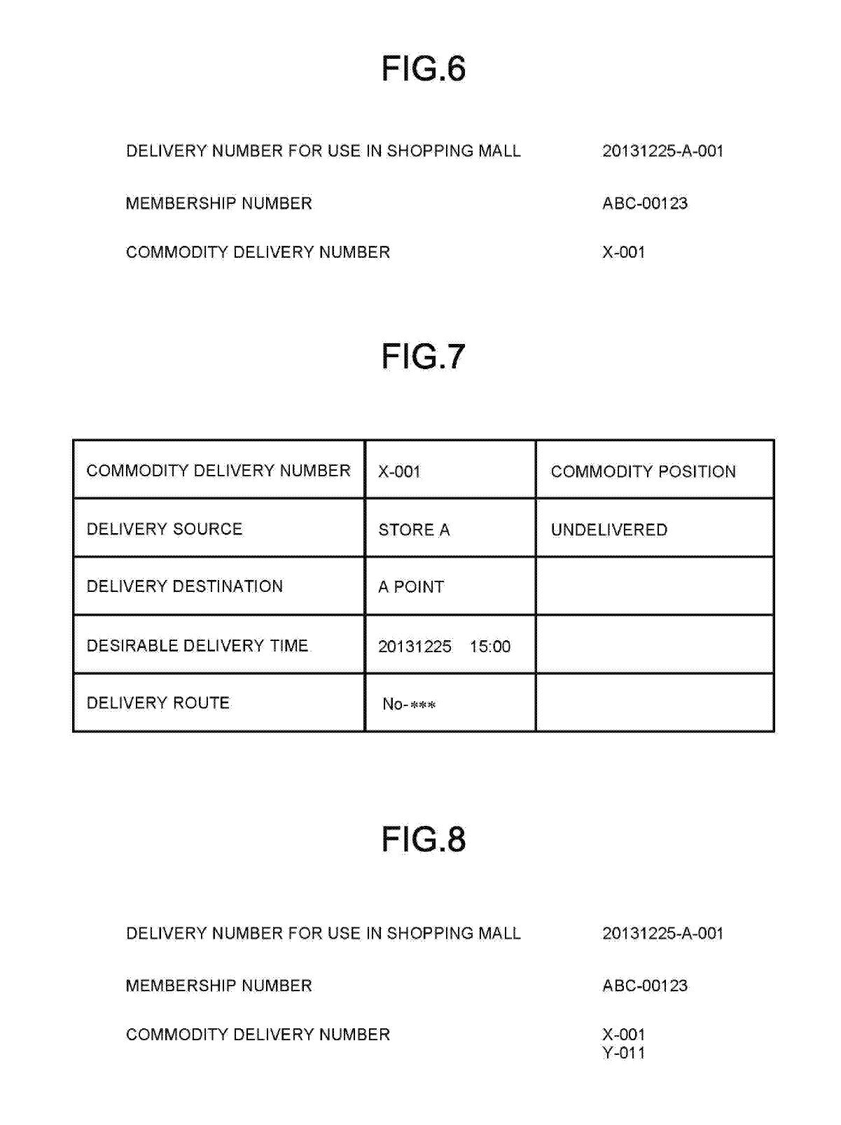

Sequentially, the delivery number management section 34 associates the delivery number for use in the whole shopping mall, the commodity delivery number with the membership number and stores the associated information in the delivery number management section 34 as an example of the information shown in FIG. 6 (S23).

Next, the delivery information management section 35 of the mall server 30 associates the delivery method information determined by the delivery method determination section 36 with the commodity delivery number and stores the associated information in the delivery information management section 35 as an example of the information shown in FIG. 7 (S24). The delivery information contains delivery source information, delivery destination information, desirable delivery time information and delivery route information.

Next, the operator writes, with the reader/writer 5, the delivery information containing the delivery method information into the RFID tag attached to the commodity (S25). Further, although it is described that an RFID tag is attached to a commodity in the embodiment, the present invention is not limited to this, a pallet having an RFID tag may be prepared so that the delivery information can be written into the RFID tag or the commodity can be accommodated in the pallet.

Next, the operator acquires delivery slip information containing the delivery number for use in the shopping mall, the membership number and the commodity delivery number from the delivery information management section 35, outputs a delivery slip using the printer 4 (S26) and delivers the delivery slip to the customer to end the commodity delivery acceptance processing (S27).

Further, for example, if the customer also purchases a commodity Y in another store the same day, then the same processing is carried out for the commodity Y using the shopping supporting system 100. Further, as a delivery number for use in the shopping mall is issued today at this time (Y in S20), instead of issuing a new delivery number, a commodity delivery number is issued (S22), and the delivery number for use in the shopping mall, the commodity delivery number and the membership number are stored in the delivery number management section 34 in an associated manner (S23). FIG. 8 shows an example of the information which is stored in the delivery information management section 35 at this time. In this way, in addition to the commodity delivery number X-001 for the commodity purchased earlier in a store, a commodity delivery number Y-011 for the commodity purchased in the current store can be added.

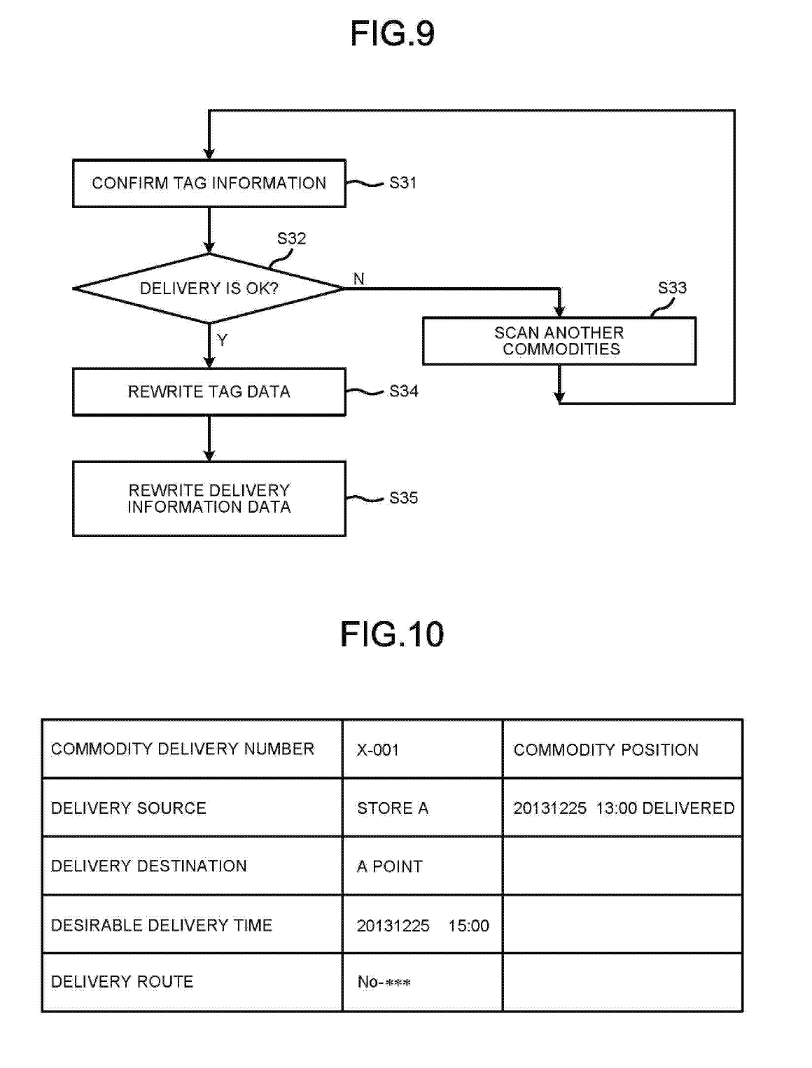

Next, the flow started after the commodity delivery acceptance processing is ended and ended before a purchased commodity is delivered using the shopping supporting system 100 from a store is described with reference to FIG. 9.

A commodity deliverer goes to a position where the commodity to be delivered is placed, such as a store in the shopping mall, and reads record information of the RFID tag attached to the commodity with the reader/writer 40 (S31). The information is sent to the delivery information management section 35 of the mall server 30, and the delivery information management section 35 determines whether or not the commodity the RFID tag of which is read can be delivered (S32) and feeds the result back to the deliverer. For example, if a delivery route passing all the delivery destinations ‘A point’, ‘B point’ and ‘C point’ is set, then the delivery of all the commodities is started, however, if there is more than one delivery route passing the store and leading to different delivery destinations, then the delivery along an incorrect route will not arrive on schedule. To prevent the occurrence of such a situation, information of the RFID tags is read, the person in charge of a correct route determines whether or not to deliver the commodities. Further, as there are many similar commodities in the store, to prevent the delivery of other commodities, whether or not the commodity the RFID tag of which is read can be delivered can be determined using the information recorded in the RFID tag.

Information of the RFID tag is confirmed by the reader/writer 40, the record information of the RFID tag of the commodity determined as deliverable (OK) (Y in S32) is rewritten as ‘the sending from the store is completed’, as in the example shown in FIG. 10 (S34), meanwhile, the information is sent to the delivery information management section 35 and information indicating ‘sent to the store’ is written into the delivery information management section 35 along with date/time data (S35). If the reader/writer 40 determines that the delivery is unachievable (N in S32) by confirming the RFID tag, then tag information of another commodity is confirmed (S33).

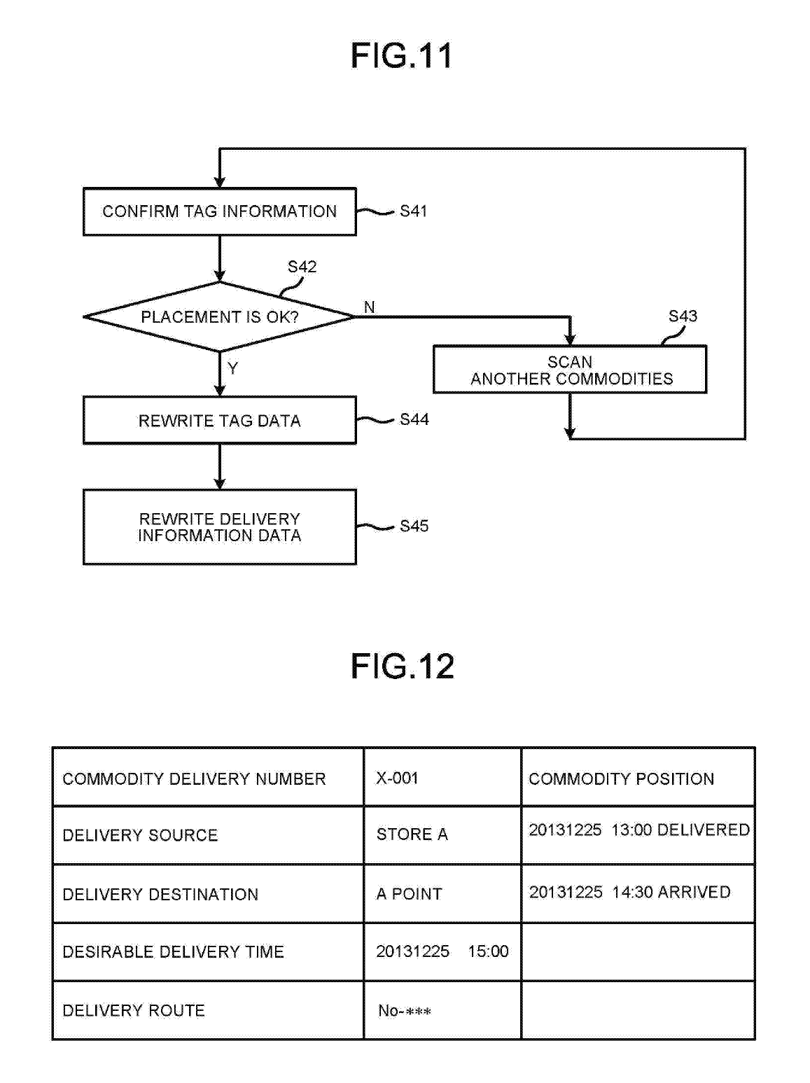

Next, the flow of the delivery of a purchased commodity using the shopping supporting system 100 from a store where a delivery is started to a delivery destination is described with reference to FIG. 11.

The commodity deliverer delivers the commodity to the delivery destination and reads the record information of the RFID tag attached to the commodity with the reader/writer 40 (S41). The information is sent to the delivery information management section 35 of the mall server 30, and the delivery information management section 35 determines whether or not the placement of the commodity the RFID tag of which is read at the position is suitable (S42) and feeds the result back to the deliverer. In this way, the placement of a commodity which should not be placed such as the placement of the commodity which should be placed at a next point at a former point can be prevented.

The RFID tag is confirmed by the reader/writer 40, the record information of the RFID tag of the commodity the placement of which is determined as OK (Y in S42) is rewritten as ‘placement at delivery destination is completed’, as the information shown in the example shown in FIG. 12 (S44), meanwhile, the information is sent to the delivery information management section 35 and information indicating ‘placed at delivery destination’ is written into the delivery information management section 35 along with date/time data (S45). If the reader/writer 40 determines that the placement at the position is not OK (N in S42) by confirming the RFID tag, then tag information of another commodity is confirmed (S43).

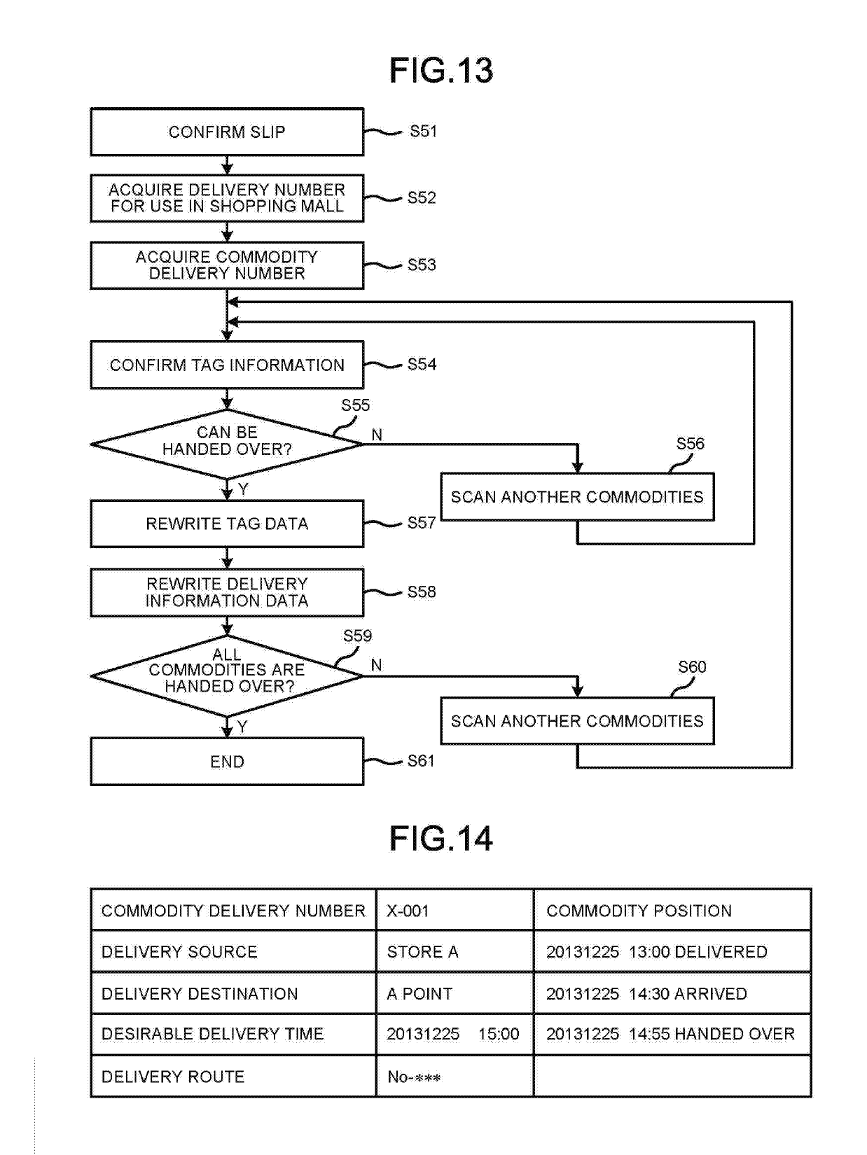

Next, the flow of the delivery of the purchased commodity using the shopping supporting system 100 until the commodity is delivered to the customer at the delivery destination is described with reference to FIG. 13.

To receive the commodity, the customer delivers a delivery slip to a commodity dispatcher at a delivery position designated as a receiving position. The commodity dispatcher confirms the delivery slip (S51), acquires the delivery number for use in the shopping mall recorded in the delivery slip with a scanner (not shown) (S52) and sends the information to the delivery information management section 35. The delivery information management section 35 feeds a matched commodity delivery number back to the reader/writer 40 of the commodity dispatcher (S53).

Sequentially, the commodity dispatcher confirms the RFID tag of the commodity placed at the placement position (S54) to determine whether or not the commodity can be handed to the customer (S55). If the commodity can be handed over to the customer (Y in S55), then the reader/writer 40 rewrites the record information of the RFID tag as ‘commodity is handed over’, as in the information shown in the example shown in FIG. 14 (S57), meanwhile, the information is sent to the delivery information management section 35 and information indicating ‘commodity is handed over to the customer’ is written into the delivery information management section 35 along with date/time data (S58). If the reader/writer 40 determines that the commodity cannot be handed over to the customer (N in S55) by confirming the RFID tag, then tag information of another commodity is confirmed (S56).

If information indicating ‘commodity is handed over’ is written into the delivery information management section 35, it is confirmed whether or not all commodities are handed over to the customer (S59). If not all commodities are handed over to the customer (N in S59), a scanning operation is carried out to search for another commodity (S60). The operation is repeated until all commodities are handed over, and when all commodities are handed over to the customer (Y in S59), the shopping supporting based on the shopping supporting system 100 is ended (S61).

In the shopping supporting system 100 described in the present embodiment, delivery information can be rewritten when a commodity is delivered from a store or arrives at a delivery destination, thus, even if in a case of desiring to receive the purchased commodity prior to a preset time, the customer can track whether or not the commodity is still in the store, being delivered from the store to a delivery position or arrives at the delivery position by confirming the data of the delivery information management section 35.

Further, the RFID tag can be read/wrote in a non-contact manner. Thus, if an RFID antenna is arranged between a store and a delivery destination, the commodity delivery information contained in the RFID tag can be rewritten during the delivery of the commodity with the antenna, moreover, the information in the delivery information management section 35 is rewritten matching with the rewriting of the information contained in the RFID tag during the delivery of the commodity, which facilitates the acquisition of information for tracking the commodity.

As stated above, according to the present embodiment, for example, by designating a receiving position and a receiving time in advance, the customer can receive the purchased commodities nearby a parking position, without carrying the commodities personally. Additionally, there is no necessary for the customer to shop in other stores with carrying the purchased commodities.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A shopping supporting system for supporting a customer in moving the purchased commodity, comprising:
a shopping supporting management server comprising a customer information management section configured to manage information of a customer using the shopping supporting system; a delivery number issuing section configured to issue the delivery number of a commodity delivered using the shopping supporting system, the delivery number is issued for a customer to use in a predetermined local area once a day; a delivery number management section configured to manage the delivery number; a delivery information management section configured to manage the delivery information of the commodity delivered using the shopping supporting system; and a delivery method determination section configured to determine a method for the delivery of the purchased commodity in the shopping supporting system;
a sales settlement terminal comprising a temporary data storage section configured to store data of the commodity to be purchased temporarily; a purchase amount calculation section configured to calculate the amount of the commodity to be purchased; a delivery condition input section configured to input a commodity delivery condition based on the shopping supporting system; and a delivery slip output section configured to output data of a delivery slip;
a store server comprising a commodity information management section configured to manage commodity information of the commodity to be purchased; and
a reader/writer configured to acquire the delivery number associated with the commodity from the code information or a tag attached to the commodity to be purchased.

2. The shopping supporting system according to claim 1, wherein
the predetermined local area is at least one shopping mall containing plural stores.

3. The shopping supporting system according to claim 1, wherein
a personal identification number is set when the delivery number is issued in the predetermined local area.

4. The shopping supporting system according to claim 1, wherein
the delivery number is issued by the delivery number issuing section according to each membership number managed by the customer information management section.

5. The shopping supporting system according to claim 1, wherein
the delivery method determination section further comprises a delivery feasibility determination section configured to determine whether or not the purchased commodity can be delivered within a delivery time.

6. The shopping supporting system according to claim 1, wherein
the tag attached to the commodity to be purchased is a non-contact tag capable of being read/written in a non-contact manner, and the shopping supporting system further comprises an antenna for reading/writing the non-contact tag in a non-contact manner in the movement path of the purchased commodity.
